(19) United States
(12) Patent Application Publication
(10) Pub. No.: US 2004/0033184 A1
(43) Pub. Date: Feb. 19, 2004

(54) Removing carbon from fly ash

(76) Inventor: Ernest Greer, Marblehead, MA (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/219,338

(22) Filed: Aug. 15, 2002

(51) Int. Cl. B01D 46/02

(52) U.S. Cl. 423/215.5

(57) ABSTRACT

A method of removing carbon from fly ash may include introducing the fly ash into one of a plurality of interconnected vertically stacked hearths of a multiple hearth furnace, heating the fly ash, exposing the fly ash to oxygen, allowing at least a portion of the carbon in the fly ash to undergo combustion, and conveying the fly ash to another of the plurality of interconnected vertically stacked hearths.

### BACKGROUND

Fly ash, a major by-product of coal combustion, is produced in very large quantities at coal-fired electric utility power plants throughout the world. In the United States alone, the annual volume of fly ash produced by such plants is reported to be in the range of 50 million tons per year. Of this total, it has been reported that only 25-30% of the fly ash is being reused commercially and that 70-75% is being disposed of in landfills. The rapidly diminishing availability of landfill space and escalating cost of land disposal have made it essential to increase the commercial applicability of coal combustion fly ash and/or separate the fly ash into components that have commercial value.

One exemplary use of fly ash is as a component of concrete. Concrete typically contains cement, such as Portland cement, water and aggregate. Fly ash, having pozzolanic characteristics, has found utility as a substitute for cement in the manufacture of concrete. Some of the advantages attributed to such fly ash as a concrete additive include increased life of the concrete structure, improved flow and pumping characteristics of the concrete, better workability and finishing capability, and decreased requirements for the amount of water and/or lime in the concrete mix. Most of these improvements are dependent upon increased and controlled air containment in the concrete mix.

The presence of unburned carbon particles in coal combustion fly ash may adversely affect the ability of the fly ash to be used as an additive in concrete. The carbon, which is relatively soft and of low strength, may not bond readily with cement and may act as a lubricant between particles in a concrete mix. The presence of carbon may also significantly alter the consistency and amount of air entrained in a concrete mix in which fly ash has been used as a substitute for cement. The carbon may adsorb air entraining agents, thereby decreasing the amount of air entrainment in the concrete and rendering the concrete susceptible to cracking during freezing and thawing cycles. State regulations and materials standards therefore limit the amount of carbon that may be present in fly ash used for the manufacture of concrete. However, fly ash produced by coal combustion can include a large fraction of carbon, in some cases up to 30% by weight or even higher, which fraction may exceed limits of state regulations or materials standards.

New combustion conditions increasingly being specified in order to minimize NOₓ and other emissions in power plant stack gases result in increased carbon content in the fly ash produced under these new conditions, thereby further restricting the types and amounts of fly ash that can be utilized in concrete.

### SUMMARY

Disclosed herein are methods for reducing the carbon content of fly ash. Methods disclosed herein permit the reduction of carbon content of fly ash by, among other things, facilitating oxidation of carbon in a multiple hearth furnace having a plurality of interconnected vertically stacked hearths.

In an embodiment, a method of removing carbon from fly ash may include introducing the fly ash into one of a plurality of interconnected vertically stacked hearths of a multiple hearth furnace, roasting the fly ash to remove at least a portion of the carbon from the fly ash, and conveying the fly ash to another of the plurality of interconnected vertically stacked hearths.

In an embodiment, the fly ash can be heated to a temperature in the range of about 1000 degrees Fahrenheit (° F.) to about 1600° F. In an embodiment, roasting can include exposing at least a portion of the carbon in the fly ash to oxygen. In an embodiment, exposing at least a portion of the carbon in the fly ash to oxygen can include stirring the fly ash with a stirring mechanism. In an embodiment, stirring may be repeated in each hearth of a plurality of successive hearths. In an embodiment, the stirring mechanism can include a rabble assembly. In an embodiment, the rabble assembly can rotate at an angular velocity in the range of 0 revolutions per minute (rpm) to about 4 rpm, preferably in the range of 1.5 rpm to about 2.5 rpm. In an embodiment, a method for removing carbon from fly ash can include recirculating a flue gas. In an embodiment, a method for removing carbon from fly ash can include removing an emission from the flue gas.

In some embodiments, roasting at least a portion of the carbon in the fly ash may include one or more of admitting air into the furnace, heating the fly ash in one or more of the hearths, and exposing carbon within the fly ash to air.

### BRIEF DESCRIPTION OF THE DRAWINGS

These and other features and advantages of the systems and methods disclosed herein will be more fully understood by reference to the following detailed description in conjunction with the attached drawings in which like reference numerals refer to like elements through the different views. The drawings illustrate principles of the systems and methods disclosed herein and are not necessarily to scale. Implied absolute or relative dimensions are not limiting but are instead provided for illustrative purposes.

FIG. 1 depicts a flowchart of an exemplary process for fly ash beneficiation.

FIG. 2 depicts schematically an exemplary apparatus for fly ash beneficiation.

FIG. 3 depicts in cross-section a portion of an exemplary apparatus for fly ash beneficiation, including a multiple hearth furnace.

FIG. 4 depicts in cross-section an exemplary hearth.

### DETAILED DESCRIPTION

To provide an overall understanding, certain illustrative embodiments will now be described; however, it will be understood by one of ordinary skill in the art that the systems and methods described herein can be adapted and modified to provide devices and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed devices or methods. Additionally, the shapes and sizes of components are also exemplary and unless otherwise specified, can be altered without affecting the disclosed systems or methods.

The present disclosure describes, among other things, methods for reducing the carbon content of fly ash. In particular, methods are described wherein fly ash is introduced into a multiple hearth furnace having a plurality of interconnected, vertically stacked hearths. Carbon in the fly ash can be roasted within the hearth, and conveyed to another hearth. Methods of emission control are also disclosed. The methods disclosed herein can facilitate the production of fly ash with low residual carbon content, also termed low loss-on-ignition fly ash.

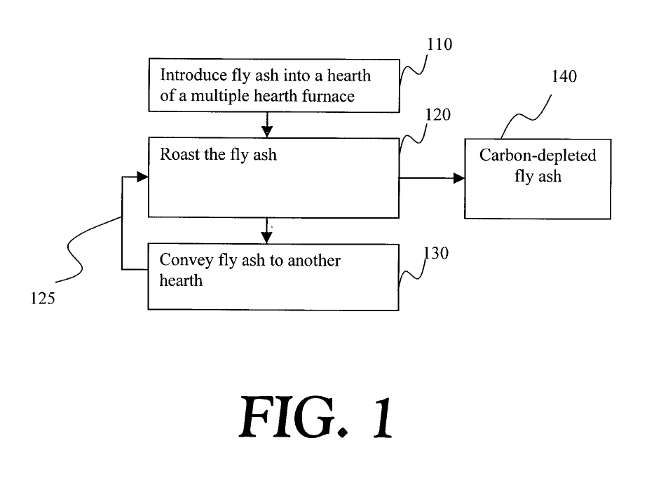

FIG. 1 depicts a flowchart of an exemplary process for reducing the carbon content of fly ash. Fly ash, obtained for example as a by-product of coal combustion, may be introduced 110 into a hearth of a multiple hearth furnace. While in the hearth, carbon in the fly ash can be roasted 120. The fly ash may then be conveyed 130 to another hearth of the multiple hearth furnace, where the roasting 120 may be repeated 125. The roasting may be repeated in each hearth of a plurality of hearths in the furnace. After a number of rounds of roasting 120, the finished product of beneficiated fly ash, which is at least partially depleted of carbon, can be obtained 140.

In an embodiment, roasting can include heating the fly ash and exposing the carbon in the fly ash to oxygen. The carbon in the fly ash can be exposed to oxygen by stirring, agitating, or otherwise physically disturbing the fly ash to allow carbon atoms or molecules entrained in the fly ash to come into proximity with oxygen molecules in the hearth.

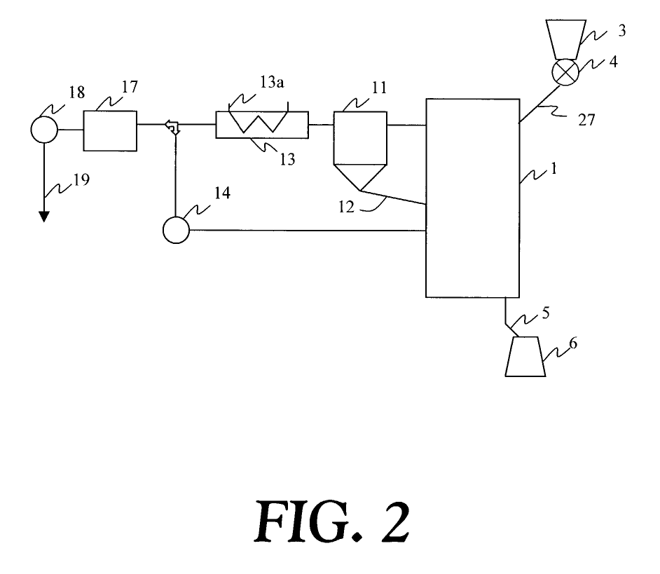

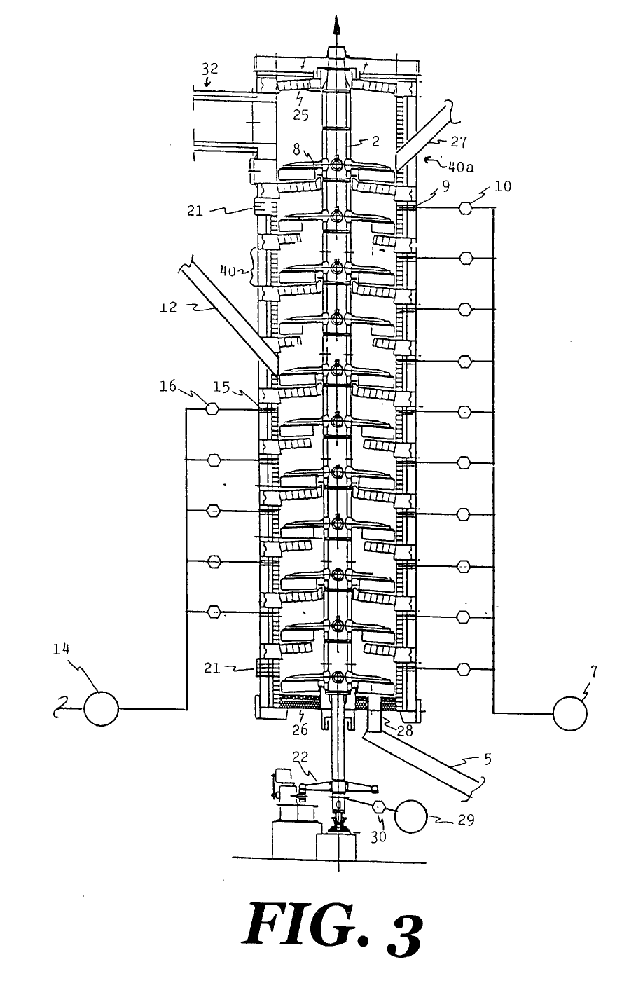

FIGS. 2 and 3 depict exemplary embodiments of systems for practicing at least some of the disclosed methods. Fly ash may be introduced into a multiple hearth furnace 1 having a plurality of interconnected vertically stacked hearths. The multiple hearth furnace 1 is discussed in greater detail below. The fly ash may be fed into a feed surge silo 3. A rotary feed valve 4 can meter the fly ash to deliver fly ash to the multiple hearth furnace 1 at a controlled rate. A feed chute 27 can convey the fly ash into the multiple hearth furnace 1. A wide variety of other introduction methods and apparatuses will be apparent to one of skill in the art.

With further reference to FIGS. 2 and 3, when in the multiple hearth furnace 1, the carbon in the fly ash can undergo roasting, as detailed elsewhere herein. Once the fly ash has completed processing in the multiple hearth furnace 1, it can be conveyed to a receiving vessel 6, such as a product surge bin. The fly ash may be conveyed to the receiving vessel 6 by a conveyor 5. The conveyor 5 can be, for example, a water-cooled screw conveyor. A water-cooled screw conveyor can simultaneously cool the product while transporting it to the receiving vessel 6. In an embodiment, a water-cooled screw conveyor can cool the fly ash from a starting temperature in the range of about 1000° F. to about 1600° F. to a temperature in the range of about 300° F. to about 600° F. The fly ash can later be conveyed by numerous methods to long term storage.

With continuing reference to FIGS. 2 and 3, the multiple hearth furnace 1 may contain flue gas during fly ash processing. The flue gas may include, for example, air, products of carbon oxidation such as carbon monoxide and/or carbon dioxide, volatilized components of the fly ash, such as volatile organic compounds, mercury, and NOₓ. Flue gas can also include entrained fly ash fines that are carried over from the furnace. The carry-over fly ash may be recovered by passing the flue gas through a separator 11, such as a cyclone separator. The cyclone separator can preferably be designed to remove about 90% or more of carry-over of fine fly ash that is emitted from the furnace 1 with the flue gas. Carryover can be in the range of 0% to about 50% of the fly ash through-put of the furnace 1. In a typical operation, carryover can be about 15% of the fly-ash though-put of the furnace 1. Captured carry-over ash can be returned by, e.g., gravity or a pump, such as a pneumatic transport (not shown). The fly ash can be returned to the furnace 1 through, for example, an ash return chute 12 as shown in FIG. 3.

Flue gas can be cooled. Cooling flue gas can facilitate controlling the temperature of the furnace 1 process, since cooled flue gas that is returned to the furnace 1 can act as a thermal mass to absorb heat in the furnace 1, as described in more detail below. Flue gas may be cooled by passing it through a gas cooler 13. In an embodiment, the gas cooler 13 can be a water cooled liquid-to-gas heat exchanger. Water may be used to cool the flue gas. Water can be run through the cooler 13 in a conduit 13a. For example, the flue gas may be cooled from a temperature in the range of about 1200° F. to about 1600° F. to a temperature of about 300° F. Flue gas can be returned to the furnace 1 by, for example, a recirculator 14, such as a fan or a pump. Recirculated flue gas may be used to control the temperature and/or speed of the reaction, as described elsewhere herein. The recirculated flue gas flow may range from 0% to 100% of the airflow to the furnace, preferably from 0% to about 50% of airflow.

Cooling the flue gas can also facilitate emissions capture by promoting precipitation of some contaminates in the flue gas. Cooling can also prepare the flue gas for emission control equipment that may be located downstream of the cooler 13, as described below in more detail. The heat given up by the flue gas during cooling may be recovered for use elsewhere, such as providing a heat source for another process, or generating steam for electricity production, or for a wide variety of other uses known to those of skill in the art.

As described and shown in FIGS. 2 and 3, cooling of flue gas can facilitate removal of selected emissions. The flue gas, in some embodiments first cooled, can be passed through an emission control system 17. The emission control system 17 may be configured to remove a variety of emissions. In particular, the emission control system 17 can include a fabric filter, for removing from the flue gas a variety of emissions, such as a particulate emission, a sulfur emission, and/or a mercury emission. The emission control system 17 can include an electrostatic precipitator to control a particulate emission. The emission control system 17 can include an activated carbon injection system, for adsorbing a mercury emission. The emission control system 17 can include a selective catalytic reactor, for removing emissions such as an oxide emission and/or an NOₓ emission. In an embodiment, a catalytic reactor can provide ammonia (NH₃) to react with an NOₓ emission to convert the NOₓ to nitrogen and water. The emission control system can include a carbon monoxide burn-off unit (afterburner) to remove carbon monoxide from the flue gas. The emission control system can include a selective noncatalytic reactor (SNCR) for removing, e.g., an NOₓ emission. In an embodiment, the SNCR can be coupled to a carbon monoxide afterburner to provide an optimal operating temperature for the SNCR in the range of about 1800° F. to about 2000° F. Other components may be included in the emission control system 17, including components that may remove emissions without first cooling the flue gas, as is known to one of skill in the art.

As shown in FIG. 2, an induced draft fan 18 may be provided downstream of the emission control system 17. The induced draft fan 18 can evacuate the flue gas from the furnace 1 and can provide a negative pressure (typically about 0.5 to about 1 inches of water gauge) in the furnace compared to atmospheric pressure. The negative pressure can facilitate the control of flue gas and dust leakage from the furnace. The negative pressure can also facilitate monitoring of the process by viewing or sampling the furnace 1 contents through a window or access port. Maintaining the furnace 1 at negative pressure can lessen the danger of explosion or escape of furnace contents through a window or access port, thereby promoting safety. An exhaust flow 19 from the induced draft fan 18 may be introduced into the flue gas streams of, for example, coal- or oil-fired boilers. The exhaust flow 19 can also be directed to atmosphere.

FIG. 3 depicts an embodiment of a multiple hearth furnace 1 in greater detail. Some examples of multiple hearth furnaces having a plurality of interconnected vertically stacked hearths are disclosed in, e.g., U.S. Pat. Nos. 976,175 to Herreshoff; 2,283,641 to Martin et al.; 4,034,969 to Grimes; 4,505,210 to Schuck et al.; 4,702,694 to Johnson et al.; and 4,842,051 to Brownlee; the foregoing enumerated patents are hereby incorporated herein by reference.

A multiple hearth furnace 1 may include a topmost refractory lined cavity 25 that can receive fly ash from one or more feed chutes 27. The topmost cavity 25 can also collect the flue gas that rises through the furnace 1 and direct the flue gas to an exit 32 for other processing, as described above. The topmost refractory lined cavity 25 can include an uppermost hearth 40a. The furnace 1 may include a bottom refractory floor 26 that can provide a gas seal below the lowest hearth and may be equipped with a exit hole 28 to couple the processed fly ash to the conveyor 5 for removal from the furnace 1.

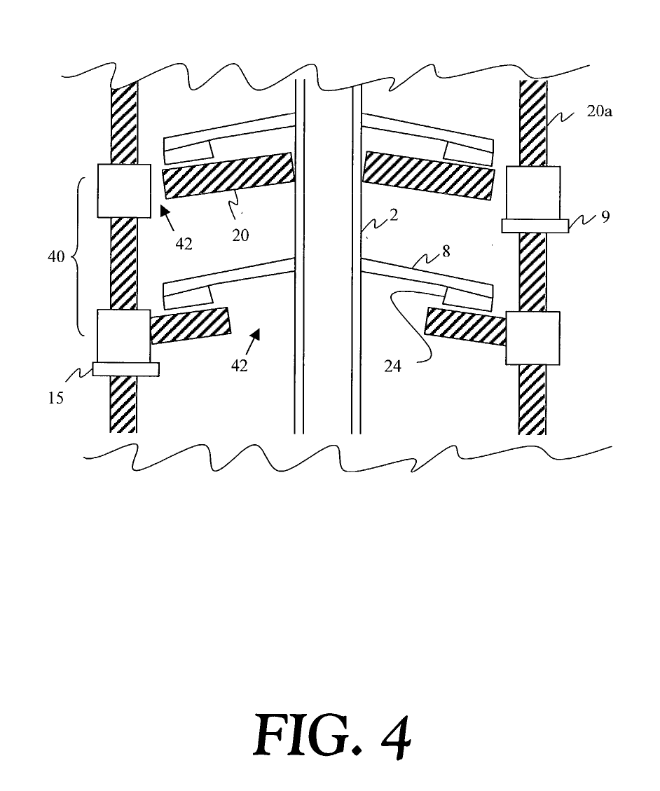

Referring to FIGS. 3 and 4, fly ash may be processed in a multiple hearth furnace 1 having a plurality of interconnected vertically stacked hearths 40. A hearth 40 may have a self-supporting circular dome 20 including interlocking firebrick refractory with a refractory brick circumferential wall 20a. A hearth 40 may have a floor defined at least in part by the dome 20 of the hearth directly below. The floor can include drop holes 42. The fly ash can be conveyed to successive lower hearths through the drop holes 42. The drop holes 42 may be laid up in the brickwork. Drop holes 42 may be located near the center of the hearth 40. Drop holes 42 may be located near the outer circumference of the hearth 40. Drop holes 42 may be located at positions between the center and the outer circumference of the hearth 40. The locations of the drop holes 42 can be selected to influence the residence time of fly ash. In one exemplary embodiment, drop holes 42 can be staggered, as depicted in FIG. 4, such that drop holes 42 are located toward the center of one hearth and located toward the outer circumference of the hearth next below. By alternating the positions of the drop holes between central and circumferential hearth by hearth, the migration path of the fly ash may be controlled and/or lengthened. Thus, the fly ash path through the process can be from the top to the bottom while flowing radially inward or outward on each hearth. In another exemplary embodiment, drop holes 42 in vertically adjacent hearths can be disposed near the outer circumference or near the center. By aligning the positions of drop holes, the migration path of the fly ash may be controlled and/or shortened. One of skill in the art would readily recognize a wide variety of arrangements for drop holes 42.

The drop holes can also facilitate passage of flue gas upward through the multiple hearth furnace 1. The flue gas path may be from the bottom upward flowing counter to the fly ash.

The fly ash may be advanced along its path by stirring. Stirring may be provided by a variety of mechanisms. A stirring mechanism can include an element that contacts a portion of the fly ash and causes the portion of fly ash to move. A stirring mechanism can urge an element through a portion of the fly ash, thereby causing the portion of fly ash to move. The stirring can cause the fly ash to move to another hearth, such as a successive lower hearth. The stirring can be repeated in each of a plurality of successively lower hearths.

In an embodiment, stirring can be provided by a rotating arm system, such as a rabble assembly. In the exemplary embodiment depicted in FIGS. 3 and 4, the stirring is provided by a rabble assembly. The assembly can have a rabble rotor 2 that extends through central openings in hearths of the furnace 1. Coupled to the rotor 2 may be a plurality of rabble arms 8. A set of rabble arms 8 may be provided to a hearth 40. A plurality of rabble teeth 24 may be coupled to the rabble arms 8. The arms 8 can support the rabble teeth 24 which can protrude into the bed of fly ash lying on the floor of the hearth 40. The shape and spacing of the teeth 24 may be optimized as is known in the art to move the fly ash radially inward or outward as well as to turn over the fly ash so as to expose new surface to the oxidation process. The number of teeth 24 per rabble arm 8 and the tooth geometric configuration can be chosen to provide the appropriate bulk movement of the bed either radially inward or outward and also to provide the appropriate turnover of the material.

As depicted in the exemplary embodiments of FIGS. 3 and 4, the rabble rotor 2 can be driven to rotate by, e.g., a motor assembly 22. The rotor 2 can thus cause the rabble arms 8 to rotate about the rotor 2. Rotation of the rabble arms 8 can cause the rabble teeth 24 to be plowed through the fly ash in a hearth 40. The plowing action can cause the fly ash to be stirred. In some embodiments, gentle perturbation of the fly ash may be preferable over vigorous agitation, to avoid kicking up fines. In other embodiments, more vigorous agitation is preferred to increase interaction opportunity between carbon and oxygen. In some embodiments, the separator 11 can recover at least some of the fines that are entrained in the flue gas during agitation. Stirring of the fly ash can expose a surface of the fly ash to oxygen in the flue gas, thereby facilitating oxidation of carbon in the fly ash. One of ordinary skill in the art would recognize that a wide variety of other stirring mechanisms can be provided. Stirring mechanisms need not include rotationally motioned elements, but can include, for example, linearly displaceable elements drawn through the fly ash, such as rakes. In an embodiment, a plurality of motors can be provided to drive the plurality of rabble arms 8.

Referring again to FIG. 3, the rotor 2 can be hollow. The rotor 2 can have an inner chamber and an outer chamber (not shown). The rotor 2 can be cooled by passing air through at least one of the inner chamber and the outer chamber. Cooling air can enter the inner chamber at the bottom of the rotor 2 and may be distributed to the rabble arms 8 for cooling. The cooling air can then be returned to the outer chamber of the rotor 2 where it can exhaust from the top of the rotor 2. The warm air may be exhausted to atmosphere or used for low grade heat recovery. Warm air can be returned to the furnace to provide heat to the carbon burn-out reaction. Returning the warm air to the furnace can facilitate maintaining an operating temperature as described elsewhere in this disclosure. Returning the warm air to the furnace can facilitate sustaining an operating temperature when the burn-out reaction is not self-sustaining, as described below. A cooling air fan 29 can be provided to deliver the cooling air to the rabble assembly. A damper 30 may be located on a supply duct to the rabble rotor 2 and can be used to modulate and balance the air requirements of the process.

The speed of rotation of the rabble assembly can be controlled by a gear ratio and/or a drive motor speed of the motor assembly 22, which may be variable speed controlled. The angular speed of rotation is preferably kept sufficiently low to avoid entraining substantial amounts of fly ash into the flue gas. For example, an angular velocity can be selected so as not to entrain more fly ash in the flue gas than can reasonably be reclaimed by the separator 11. In certain exemplary embodiments, the angular velocity of the rabble assembly may be between 0 rpm and about 4 rpm, preferably in the range of 0 rpm to 1.5 pm. A more preferable speed may be in the range of about 1.5 rpm to about 2.5 rpm. A speed may be provided between about 2.5 rpm and about 4 rpm. A speed above about 4 rpm may be adopted if entrained fly ash can be recovered.

With continued reference to FIGS. 3 and 4, a hearth 40 may be equipped with an air port 9, to convey air into the hearth 40 from an air supply such as an air fan 7. A damper 10 may be provided to regulate air flow into the hearth 40. The exemplary embodiment depicted in FIG. 3 shows a single air fan 7 providing air to a plurality of hearths 40. One skilled in the art would recognize that additional fans can be provided. A fan can be provided for a plurality of hearths or for each hearth. Also as depicted in FIG. 3, air ports 9 are provided to a plurality of sequential hearths 40. One skilled in the art would recognize that the air ports 9 need not be provided to sequential hearths 40; hearths can be skipped. Additionally as depicted in FIG. 3, a damper 10 is provided to each of a plurality of hearths 40. One skilled it the art would recognize that one damper 10 can be provided to regulate air flow to more than one air port 9.

In an embodiment, varying flow rates of air can be provided to various hearths 40 by selectively regulating air flow through the air ports 9 that supply air to those hearths. For example, greater flow rates of air can be provided to lower hearths compared to upper hearths, to supplement oxygen that may be depleted in lower hearths. In an embodiment, excess air can be provided selectively to the lower hearths to begin cooling fly ash that is nearing the end of its migration path in the furnace 1. An air port 9 and/or air fan 7 can be provided with a safety shut-off feature that can halt air flow into the furnace 1, thereby slowing or stopping the reaction. One or more hearths can be provided with a sensor to detect a process parameter. For example, the sensor can be a thermometer to measure a temperature in a hearth. In another example, the sensor can be a carbon monoxide sensor to measure carbon monoxide in the flue gas. In another example, the sensor can be an oximeter to measure oxygen in the flue gas. A wide variety of other sensor types to detect process variables will be readily apparent to one of skill in the art. Flow rates of, e.g., recirculated flue gas and/or air can be regulated in response to a measurement made by a sensor. Regulation of air flow can be provided by using, for example, one or more dampers or control valves positioned within the air supply and/or recirculated flue gas lines. One or more dampers may be automatically controlled from a centralized location. The control system can be in proximity to the furnace or a hearth or may be positioned remotely. Alternatively, the dampers may be manually controlled.

As depicted in FIGS. 3 and 4, a hearth 40 may be provided with a flue gas recirculation port 15 to receive recirculated flue gas as described above. A recirculation port damper 16 can be provided to regulate the recirculation of flue gas as necessary to control the temperature of carbon oxidation reaction. In the embodiment depicted in FIG. 3, recirculation ports are provided to a portion of the hearths located toward the bottom of the furnace 1. This can facilitate the flow of recirculated flue gas through a fuller height of the furnace than if the recirculated flue gas is injected into hearths closer to the top. However, one of ordinary skill in the art would recognize that flue gas recirculation ports can be provided to one or more hearths, whether those hearths be toward the top of the furnace 1, toward the bottom, adjacent to one another, and/or dispersed along the height of the furnace 1. Also as depicted in FIG. 3, a recirculation port damper 16 may be provided to regulate each recirculation port 15. However, one of skill in the art would recognize that a single recirculation port damper 16 can be provided to regulate recirculated gas flow to more than one recirculation port 15.

The furnace 1 can provide an appropriate environment to oxidize the carbon contained within coal fly ash. Several variables contribute to providing an appropriate environment, including the appropriate time for that reaction to occur, the appropriate temperature for the reaction to take place, and the appropriate mechanism to allow an “interaction opportunity” between the carbon and the oxygen.

In an embodiment, the roasting can include complete combustion, in which carbon is fully oxidized to carbon dioxide. In an embodiment, the roasting can include incomplete combustion, in which carbon is oxidized to carbon monoxide.

As depicted in FIG. 3, a hearth 40 may be provided with an external heat port 21 to provide heat to the furnace 1. Temperature in the furnace 1 may be controlled by heat input through the external heat port 21, by energy given off by the oxidizing and/or roasting process, by insulation provided by the refractory, by excess air provided to the hearths, and/or by cooled flue gas recirculated to the hearths. The external heat port 21 can conduct heat from an external heat source, such as by admitting a heated gas to the furnace 1. The external heat port 21 can be a burner port, in which a combustible substance, such as natural gas, is burned to produce heat. In the embodiment depicted in FIG. 3, one external heat port 21 is provided in a hearth 40 toward the top of the furnace 1. However, one of skill in the art would recognize that more than one external heat port 21 can be provided, and that external heat ports can be provided at a variety of positions along the height of the furnace 1.

The furnace 1 can be started by providing an external fuel source such as natural gas which is burned in the external heat ports 21 of various hearths 40. The number and location of the start up external heat ports 21 can be chosen to facilitate a uniform warm-up of the furnace refractory. The fly ash processing may be started once the furnace refractory reaches an appropriate operating temperature. Depending on various factors, such as starting fraction of carbon in the fly ash, desired ending fraction of carbon in the fly ash, and/or ash fusion temperature for the mineral portion of the fly ash, an appropriate operating temperature can be in the range of about 1000° F. to about 1600° F., preferably about 1200° F. to about 1500° F., more preferably from about 1300° F. to about 1500° F. Once the carbon burnout process has started, the gas burners may be shut off, as the oxidation and/or roasting can be self-sustaining. External heat ports 21 can be turned on during the reaction to provide additional heat, for example, to help sustain the temperature in a reaction which is not yet self-sustaining or has become non-self-sustaining.

If the starting carbon content of the fly ash is low, then the reaction might not be self-sustaining, since insufficient heat is generated by oxidation and/or roasting of the small fraction of carbon in the fly ash. The “critical fraction” of carbon for a self-sustaining reaction depends on a variety of factors, such as the residence time, number of hearths, physical form of the carbon (i.e., whether it has a smooth surface or a porous surface, the porous surface of so-called “activated carbon” typically having a larger surface area than a smooth surface and thus better facilitating interaction between air and the carbon), the rates of recirculated flue gas and/or warm air from the rotor, the number and/or locations of recirculation ports 15 and air ports 9, and other factors. The critical fraction can be in the range from about 4% to about 10%, typically in the range from about 5% to about 6%.

Fly ash having marginal or insufficient carbon content to sustain the reaction can be mixed with carbon or a carbon-containing substance to increase its total carbon content. For example, coal or coal fines can be mixed into the fly ash. As another example, fly ash having a high carbon content can be mixed with fly ash having a lower carbon content. The starting carbon content of the fly ash can thus be controlled, by mixing the fly ash with various carbon sources, to be in a predetermined range. For example, the carbon content of fly ash can be measured or calculated (for example, by burning a test quantity and determining the heat produced thereby), and the fly ash can be enriched with carbon to bring its carbon content to a desired level or into a desired range. Providing fly ash with a carbon content at a relatively constant level or in a relatively constant range can simplify design and operation of the multiple hearth furnace and another components of the apparatus described herein, since various parameters can be fixed, given the expectation that the carbon content is constant. Parameters than can be fixed include, for example, number of hearths, recirculated flue gas percentage, excess air percentage, fly ash input rate, and others.

The temperature in a hearth 40 may be controlled, for example, by modulating the amount of air provided to the hearth 40 through the air port 9. Adding air to a hearth 40 at a rate in excess of that sufficient to facilitate complete combustion can lower the temperature in the hearth 40 because the excess air can absorb some of the heat in the hearth 40. The amount of excess air may range from 0% to about 200%, preferably from about 50% to about 100%. Hearth temperature can be controlled to fall in ranges as described above. Operating with excess air in the hearths is typically denoted as the oxidizing atmospheric mode of operation. The oxidizing atmospheric mode can facilitate complete combustion.

The furnace can also be operated in a pyrolytic mode, in which the process is at least partially starved of oxygen. The burn rate of carbon and/or the temperature of the reaction can be controlled by adjusting the amount of oxygen provided to the hearths 40. Carbon monoxide may be produced by pyrolitic processing, and can removed from the flue gas as described elsewhere herein. The upper hearths of a furnace 1 can act as an afterburner. In an embodiment, carbon monoxide produced in oxygen-starved lower hearths can rise through the furnace 1 to upper hearths, were it can burn readily.

The preferred residence time of the fly ash in the process at a given temperature may be influenced by the carbon burn rate. Residence time can be controlled by hearth diameter, number of hearths 40, and rabble tooth 25 speed. Diameters of multiple hearth furnaces that are available commercially typically range from 5 feet to 25 feet, although other diameters are contemplated. The preferred diameter is 25 feet, since manufactures of multiple hearth furnaces standardize on furnace diameters to control the cost of the refractory brick components of the furnace. In order to develop specific furnace sizes, manufactures typically instead adjust the number of stacked hearths. The residence time required can affect the number of stacked hearths preferred. In an embodiment, the preferred number of hearths can be from 1 to 20, preferably from 6 to 16, more preferably from 10 to 12. Rotation speed of the rabble assembly can also control residence time, as described above. Rabble tooth 24 speed can likewise control the residence time in the furnace 1. Rabble tooth 24 speed can be modulated via a variable speed drive of the motor assembly 22, for example, to accommodate the variability of carbon content of the feedstock.

Methods disclosed herein can facilitate the production of fly ash with reduced carbon content. Disclosed methods can facilitate production of fly ash having a carbon content of a desired amount or in a desired range. The carbon content of fly ash produced by disclosed methods can be controlled by employing, for example, chosen temperatures, oxygen supply, interaction time, residence time, and other factors as disclosed herein. Fly ash can be produced having a carbon content of less than 6% by weight. Fly ash can be produced having a carbon content of less than 4% by weight. Fly ash can be produced having a carbon content of less than 2% by weight. Fly ash can be produced having a carbon content of less than 1% by weight. Fly ash can be produced having a carbon content of less than 0.5% by weight. Carbon content of fly ash produced by methods disclosed herein can be selected for compliance with regulations and/or material specifications can require that carbon content of fly ash be reduced to less than specified levels.

Process parameters can be selected to produce fly ash having, on average, a carbon content less than one of the levels described above even when the input fly ash has varying carbon content. For example, process parameters can be selected to produce ideally fly ash having less than 1% carbon by weight from input fly ash having 12-14% carbon by weight. In such a situation, input fly ash having a carbon content above that of 12-14% can be run through the process and still produce a fly ash having an overall carbon content of, for example, less than 2%, which can still be adequate for a particular purpose. In another example, a portion of the input fly ash can have a higher-than-expected carbon content, while the remainder of the input fly ash has an expected and/or below-expected carbon content. The process parameters can be selected so as to assure that enough carbon is burned out so that the average carbon content of the product is below a desired percentage. Thus, a product having a carbon content of a desired amount can be produced even when the input fly ash has a variable carbon content.

In some situations, higher fractions of carbon may be desired and can be achieved by practicing methods disclosed herein, such as when less air entrainment is necessary (e.g., for concrete used in a mild climate that does not experience extremes of temperature), or when additional water and/or air entraining agent is added to the concrete in compensation.

The amount of oxygen and/or air sufficient for carbon burnout can be determined as described in the following exemplary embodiment. It will be understood that quantities, dimensions, and rates provided in this example are for illustrative purposes only. One of skill in the art could readily adapt the equations and calculations provided herein to a carbon burnout process of arbitrary scale, input parameters, and output products. The oxygen content of air employed herein is also used for illustrative purposes only, it being understood that other values, such as 21% or 20.9%, can be used instead.

In this exemplary embodiment, one ton per hour of coal fly ash with a carbon content of 25% is reduced to a pozzolan with a carbon content of 2%. The initial weight split of the coal fly ash is 500 lb carbon and 1500 lb non-carbon. The final desired weight split in the pozzolan, after burnout, is 30 lb carbon and 1500 lb non-carbon. To achieve the final desired weight split of the coal fly ash, a carbon reduction rate of at least 470 lb per hour may be utilized.

The chemical equation for complete combustion is:

1 mol C+1 mol O₂→1 mol CO₂ (1)

In terms of weight, this becomes:

12 lb C+32 lb O₂→44 lb CO₂ (2)

or

1 lb C+2.667 lb O₂→3.667 lb CO₂. (3)

Presuming that air includes 22.8% oxygen, the ratio of air to oxygen is 1/0.228 or 4.386 lb air per pound of O₂. Therefore, for 1 lb of carbon to be burned, 11.68 lb of air (2.667 lb O₂×4.386 lb air per lb O₂) is required, according to Eq. 3, above. Applying this rate to the expected carbon reduction of 470 lb per hour gives

470 (lb C)/hr×11.68 (lb air)/(lb C)→5489 (lb air)/hr. (4)

This is stoichiometric air Aₛ, which is the theoretical minimum associated with complete combustion.

In order to provide an “interaction opportunity” for the carbon and oxygen in the air to react, excess air beyond the stoichiometric minimum can be provided to the process. This may range from, e.g., 0-10% excess air for reactions that are vigorous, to 100% excess air or more for reactions that are sedate. In addition, excess air may be provided to control the temperature of the roasting process. The excess air can absorb heat in the reaction. In some embodiments, air far in excess of the stoichiometric minimum can be provided, as high as 200% or higher, for temperature control. Total air rate A which includes excess percent E can be determined as follows:

E=100×(A−Aₛ)/Aₛ (5)

Therefore, in this exemplary embodiment, one ton per hour of coal fly ash with 25% carbon content can be processed to a 2% carbon content pozzolan using 100% excess air by providing A lb O₂ per hour as follows:

100=100×(A−5489 lb air/hr)/5489 lb air/hr (6)

or

A=1×(5489 lb air/hr)+5489 lb air/hr (7)

which gives a total air rate A of at least 10,978 lb air/hr to roast one ton of 25% carbon fly ash to 2% pozzolan per hour with 100% excess air.

While the systems and disclosed methods herein have been particularly shown and described with references to exemplary embodiments thereof, it will be understood by those skilled in the art that various changes in form and details may be made therein without departing from the spirit and scope of the disclosure. Those skilled in the art will recognize or be able to ascertain using no more than routine experimentation, many equivalents to the exemplary embodiments described specifically herein. Such equivalents are intended to be encompassed in the scope of the present disclosure.

I claim:

1. A method of removing carbon from fly ash, comprising:
introducing the fly ash into one of a plurality of interconnected vertically stacked hearths of a multiple hearth furnace;
roasting the fly ash to remove at least a portion of the carbon from the fly ash; and
conveying the fly ash to another of the plurality of interconnected vertically stacked hearths.

2. The method of claim 1, wherein roasting comprises heating the fly ash to a temperature in the range from about 1000 degrees Fahrenheit (° F.) to about 1600° F.

3. The method of claim 1, wherein roasting comprises heating the fly ash to a temperature in the range from about 1300° F. to about 1500° F.

4. The method of claim 1, wherein roasting comprises exposing at least a portion of the carbon in the fly ash to oxygen.

5. The method of claim 4, wherein exposing comprises stirring the fly ash with a stirring mechanism.

6. The method of claim 5, wherein the stirring mechanism comprises a rabble assembly disposed in a central shaft of the multiple hearth furnace, the assembly having a rabble rotor, a plurality of rabble arms coupled to the rabble rotor, and a plurality of rabble teeth coupled to the plurality of rabble arms, the rabble rotor rotating the plurality of rabble arms about the rabble rotor, and the rabble teeth stirring the fly ash.

7. The method of claim 6, wherein the rotating has an angular velocity in the range of 1.5 revolutions per minute (rpm) to about 2.5 rpm.

8. The method of claim 6, wherein the rotating has an angular velocity in the range of about 0 rpm to about 1.5 rpm.

9. The method of claim 6, wherein the rotating has an angular velocity in the range of about 2.5 rpm to about 4 rpm.

10. The method of claim 6, wherein the rotating has an angular velocity sufficiently low to prevent substantial entrainment of the fly ash.

11. The method of claim 1, further comprising recirculating a flue gas.

12. The method of claim 11, wherein the recirculated flue gas provides from 0 percent to about 50 percent of airflow to the multiple hearth furnace.

13. The method of claim 11, wherein recirculating the flue gas comprises passing the flue gas through a gas cooler, and reintroducing the flue gas into at least one of the plurality of interconnected vertically stacked hearths.

14. The method of claim 11, further comprising removing an emission from the flue gas.

15. The method of claim 14, wherein removing comprises passing the flue gas through an emission control system, the system including at least one of:
a fabric filter, for removing from the flue gas at least one of a particulate emission and a mercury emission;
an activated carbon injection system, for adsorbing a mercury emission;
an electrostatic precipitator, for removing a particulate emission;
a selective catalytic reactor, for removing at least one of an oxide emission and an NOₓ emission; and
a selective noncatalytic reactor, for removing an NOₓ emission.

16. The method of claim 11, further comprising passing the flue gas through a cyclone separator to remove carry-over fine fly ash from the flue gas.

17. The method of claim 1, further comprising admitting air into the furnace.

18. The method of claim 1, further comprising exposing at least a portion of the carbon in the fly ash to sufficient oxygen to permit complete combustion of the carbon.

19. The method of claim 1, further comprising exposing the fly ash to excess oxygen to control a temperature of the fly ash.

20. The method of claim 1, further comprising admitting oxygen into the furnace at a rate sufficient to induce a pyrolytic mode of carbon removal.

21. The method of claim 1, wherein the fly ash is roasted to reduce a fraction of carbon in the fly ash to below 2 percent by weight.

22. A method of removing carbon from fly ash, comprising:
introducing the fly ash into one of a plurality of interconnected vertically stacked hearths of a multiple hearth furnace;
heating the fly ash within the hearth; and
stirring the fly ash to allow at least a portion of the carbon in the fly ash to interact with oxygen, and to convey the fly ash to another of the plurality of interconnected vertically stacked hearths.

23. The method of claim 22, wherein stirring comprises moving at least a portion of the fly ash with a rotating arm system.

24. The method of claim 23, wherein the rotating arm system rotates with an angular velocity in the range of 0 rpm to about 2 rpm.

25. A method of removing carbon from fly ash, comprising:
introducing the fly ash into an uppermost hearth of a multiple hearth furnace, the furnace having a plurality of interconnected vertically stacked hearths;
admitting air into the furnace;
heating the fly ash within the hearth;
stirring the fly ash with a rabble assembly to allow at least a portion of the carbon in the fly ash to interact with oxygen within the hearth, and to convey the fly ash to successive lower hearths of the plurality of interconnected vertically stacked hearths; and
recirculating a flue gas to control a temperature of the fly ash, recirculating including passing the flue gas through a gas cooler, and reintroducing the flue gas into at least one of the plurality of interconnected vertically stacked hearths.

26. The method of claim 25, further comprising repeating stirring in each of a plurality of successive lower hearths.
